(19) United States
(12) Patent Application Publication
(10) Pub. No.: US 2016/0263732 A1
(43) Pub. Date: Sep. 15, 2016

(54) MAGNETIC SOCKET ADAPTERS AND SOCKET DRIVERS

(71) Applicant: BLACK & DECKER INC., New Britain, CT (US)

(72) Inventors: Marco LOURENCO, Baltimore, MD (US); Donald R. PERRON, North Smithfield, RI (US); James R. NIBLETT, Ellicott City, MD (US); Michael P. PETERS, Lutherville, MD (US)

(21) Appl. No.: 15/064,659

(22) Filed: Mar. 9, 2016

Related U.S. Application Data
(60) Provisional application No. 62/132,800, filed on Mar. 13, 2015.

(51) Int. Cl. B25B 23/00; B25B 23/12

(52) U.S. Cl. CPC B25B 23/0035; B25B 23/005; B25B 23/12

(57) ABSTRACT

A magnetic socket adapter is configured to be removably coupled to a plurality of differently sized socket drivers. The adapter includes a rear shank configured to be coupled to a tool holder or chuck of a power or hand tool and a front shaft coupled to the shank and defining a longitudinal axis. The front shaft has a head with a polygonal outer surface configured to be received in a corresponding polygonal shaped opening in each of the plurality of socket drivers. A magnet is coupled to a front end of the front shaft. A retaining projection is coupled to the head to removably retain each of the plurality of socket drivers on the adapter. An outer conical centering surface is disposed on the front shaft and configured to abut a corresponding internal conical centering surface in the polygonal opening in each of the plurality of socket drivers to center the socket drivers on the front shaft.

### CROSS REFERENCE TO RELATED APPLICATIONS

This application is claims priority, under 35 U.S.C. §119(e), to U.S. Provisional Application No. 61/132,800, filed Mar. 13, 2015, which is incorporated herein by reference.

### TECHNICAL FIELD

This application relates to magnetic socket adapters and socket drivers.

### BACKGROUND

FIGS. 1A and 1B show a prior art embodiment of a socket adapter 10 with a plurality of socket drivers 20. The adapter 10 has a rear hex-shaped shank 14 with an annular groove 16 for retaining the adapter 10 in a tool holder or chuck of a power tool or hand tool. The adapter 10 also has a front square-shaped head 18 with a retaining ball 12 that is biased radially outward. Each socket driver 20 has a front portion 22 with a hex-shaped socket 24 of a different size to drive different sized nuts or fasteners, and a rear portion 26 with a square-shaped opening for receiving the front head 18 of the adapter 10 to removably retain the socket driver 20 on the adapter 10.

FIGS. 2A and 2B show another prior art embodiment of a set 30 of socket drivers 32. Each socket driver 32 has a rear hex-shaped shank 34 with an annular groove 36 for retaining the socket driver 32 in a tool holder or chuck of a power tool or hand tool. Each socket driver 32 also has a front portion 36 with a hex-shaped socket 38 of a different size for driving different sized nuts or fasteners. A magnet 40 is received in the bottom of each socket 38 for retaining the nut or fastener inside of the socket 38.

### SUMMARY

This application relates to a magnetic socket adapter with a common magnet compatible with multiple sized socket drivers for improved functionality and value replacement of current socket drivers.

In an aspect, a magnetic socket adapter is configured to be removably coupled to a plurality of differently sized socket drivers. The magnetic socket adapter includes a rear shank configured to be coupled to a tool holder or a chuck of a power tool or a hand tool. A front shaft is coupled to the shank and defines a longitudinal axis. The front shaft has a head with a polygonal outer surface configured to be received in a corresponding polygonal shaped opening in each of the plurality of socket drivers. A retaining projection is coupled to the head and is configured to removably retain each of the plurality of socket drivers on the head. A magnet is coupled to a front end of the front shaft. An outer conical centering surface disposed on the front shaft and configured to abut a corresponding internal conical centering surface in the polygonal opening in each of the plurality of socket drivers to center the socket drivers on the front shaft.

Implementations of this aspect may include one or more of the following features. The front shaft may have a projection extending axially forward of the head, the bore being defined in the projection. The outer conical centering surface may be disposed at a junction between the head and the projection or on a front end of the projection. The retaining projection may include at least one of a ball and an elastomeric ring extending radially outward from the head to engage a corresponding groove in the polygonal opening in each of the plurality of socket drivers. The magnet is coupled to a magnet holder received in a bore in the front shaft and configured to float axially along the longitudinal axis by a limited extent relative to the front shaft. A spring may bias the magnet holder axially forward. The magnet holder may include a groove (e.g., an axial slot or an annular groove) having a front end and a rear end and the front shaft may have a stop (e.g., a cross pin or a ring) fixedly attached to the front shaft, where the magnet holder can move axially between a rear position where the stop engages the front end of the groove and a front position in which the stop engages the rear end of the groove. The magnet holder may configured to float axially without being biased in an axial direction.

In another aspect, a magnetic socket adapter set includes a plurality of differently sized socket drivers and a magnetic socket adapter. Each socket driver has a rear end portion with a polygonal opening and a front end portion with a polygonal socket configured to receive a nut or fastener. The magnetic socket adapter has a rear shank configured to be coupled to a tool holder or a chuck of a power tool or a hand tool, a front shaft coupled to the shank, and a magnet coupled to a front end of the front shaft. The front shaft defines a longitudinal axis and has a head with a polygonal outer surface configured to be received in the polygonal opening in each of the plurality of socket drivers. The head includes a retaining projection configured to removably retain each of the plurality of socket drivers on the adapter. The front shaft includes an outer conical centering surface configured to abut a corresponding internal conical centering surface in the polygonal opening in each of the socket drivers to facilitate centering the socket drivers on the front shaft.

Implementations of this aspect may include one or more of the following features. The front shaft may have a projection extending axially forward of the head, the bore being defined in the projection. The outer conical centering surface may disposed at a junction between the head and the projection or on a front end of the projection. The retaining projection may include at least one of a ball and an elastomeric ring extending radially outward from the head to engage a corresponding groove in the polygonal opening in each of the plurality of socket drivers. The magnet may be coupled to a magnet holder received in a bore in the front shaft with the magnet holder configured to float axially along the longitudinal axis by a limited extent relative to the front shaft. A spring may bias the magnet holder axially forward from the bore. The floating magnet assembly may include a groove having a front end and a rear end defined in the magnet holder and a stop fixedly attached to the front shaft, where the magnet holder can move axially between a rear position where the stop engages the front end of the groove and a front position in which the stop engages the rear end of the groove. The magnet holder may be configured to float axially without being biased in an axial direction. The set may further include a drive guide having a socket shaft configured to be removably retained on the head of the adapter, and a sliding sleeve received over the socket shaft and configured to be slidable between a rearward position and a frontward position.

This design addresses a common user frustration by allowing the user to remove the socket driver and clean off metal shavings that collect on the magnet. Advantages of this design include one or more of the following: Magnets can be easily cleaned of metal shavings. Sizes can be easily removed and attached to change sizes without disengaging the shank from a power tool.

### BRIEF DESCRIPTION OF THE DRAWINGS

FIGS. 1A and 1B are perspective views of a prior art adapter and socket driver set.

FIG. 2A is a perspective view of another embodiment of a prior art set of socket drivers.

FIG. 2B is a front end view of one of the socket drivers of FIG. 2A.

FIG. 3 is a perspective view of a first embodiment of a magnetic socket adapter and socket driver.

FIGS. 4A-4C are perspective views of a second embodiment of a magnetic socket adapter and socket driver.

FIGS. 5A-5C are perspective views of a third embodiment of a magnetic socket adapter and socket driver.

FIG. 6A is a cross-sectional view of a fourth embodiment of a magnetic socket adapter and socket driver.

FIG. 6B is a side view of the magnetic socket adapter of FIG. 6A.

FIG. 6C is a front end view of the magnetic socket adapter of FIG. 6A.

FIG. 7 is a cross-sectional view of a fifth embodiment of a magnetic socket adapter and socket driver.

FIG. 8 is a cross-sectional view of a sixth embodiment of a magnetic socket adapter and socket driver.

FIG. 9 is a cross-sectional view of a seventh embodiment of a magnetic socket adapter and socket driver.

FIG. 10 is a cross-sectional view of an eighth embodiment of a magnetic socket adapter and socket driver.

FIG. 11 is a cross-sectional view of a ninth embodiment of a magnetic socket adapter and socket driver.

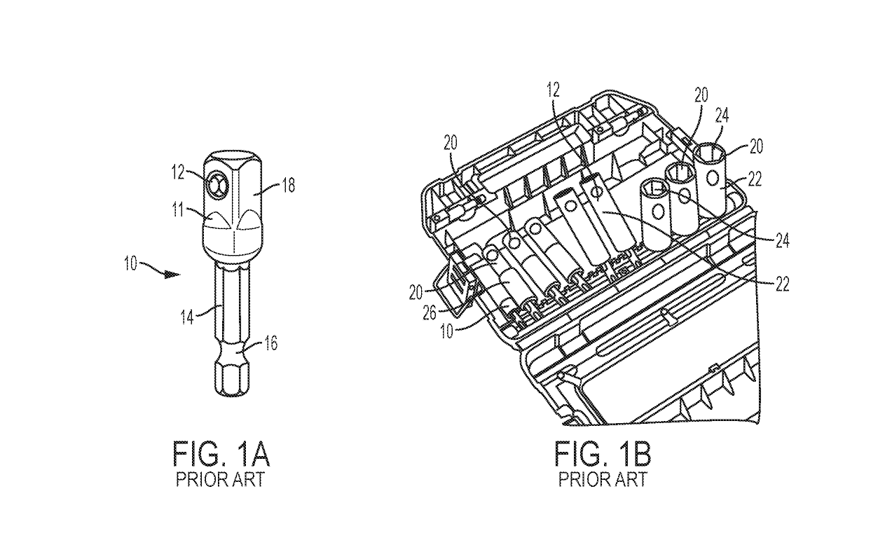

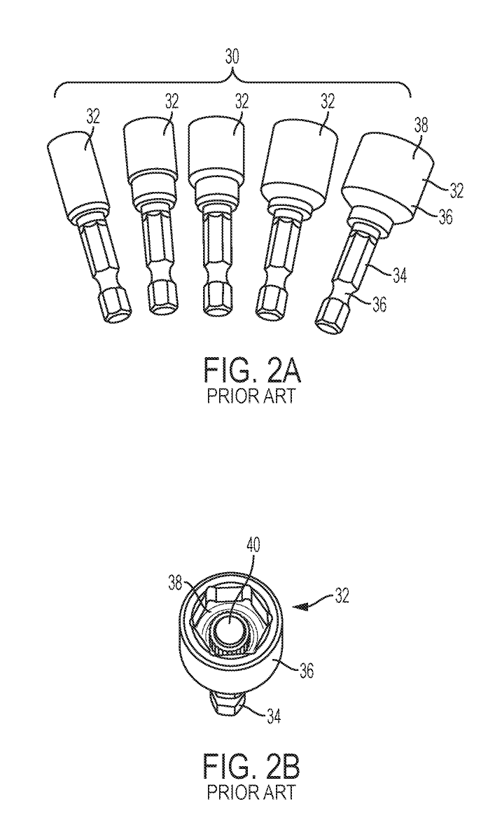

### DETAILED DESCRIPTION OF THE DRAWINGS

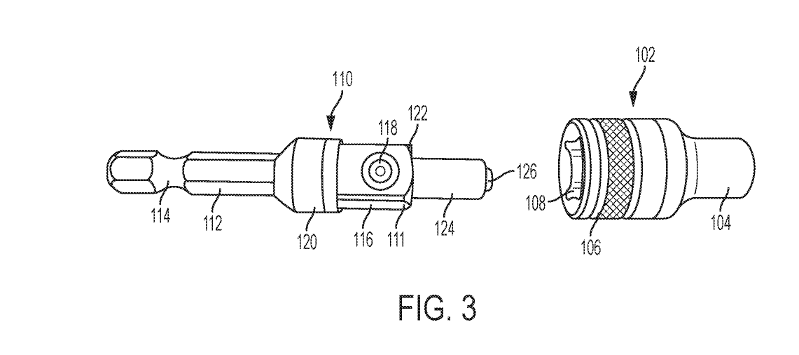

FIG. 3 shows a first embodiment of a magnetic socket adapter 110 for use with a plurality of socket drivers 102 of different sizes. The adapter 110 has a rear polygonal (e.g., hex) shaped shank 112 with an annular groove 114 for retaining the adapter 110 in a tool holder or chuck of a power tool or hand tool. The adapter 110 also has a front shaft 111 having a polygonal (e.g., hex or square) shaped head 116 with a retaining ball 118 that is biased radially outward for removably retaining a socket driver 102. A round intermediate shaft 120 is disposed between the shank 112 and the head 116. A ledge 122 is formed on the front of the round intermediate shaft 120 at the junction with the front head 116 so that the base of the socket driver 102 rests against the ledge 116 when it is coupled to the adapter 110. The front shaft 111 also has a non-polygonal (e.g., cylindrical or double-D shaped) projection 124 with a magnet 126 at its front end extending axially forward of the head 116.

Each socket driver 102 has a front portion 104 with a polygonal (e.g., hex) shaped socket of a different size to drive different sized nuts and fasteners. Each socket driver 102 also has a rear portion 106 with a polygonal (e.g., hex or square) shaped opening 108 for receiving the front head 116 to retain the socket 102 on the adapter 110. Each socket also has a cylindrical bore (not shown) extending between the polygonal socket in the front portion 104 and the polygonal opening 108 in the rear portion 106 for receiving the projection 124 of the adapter 110. When the socket driver 102 is coupled to the adapter 110, the projection 124 extends through the cylindrical bore so that the magnet 126 is positioned at the bottom of the socket to retain a nut or fastener inside the socket. This design enables a socket driving set having multiple sized magnetic socket drivers able to be coupled to a single adapter having only one magnet, which greatly reduces the cost of a set of multiple sized socket drivers.

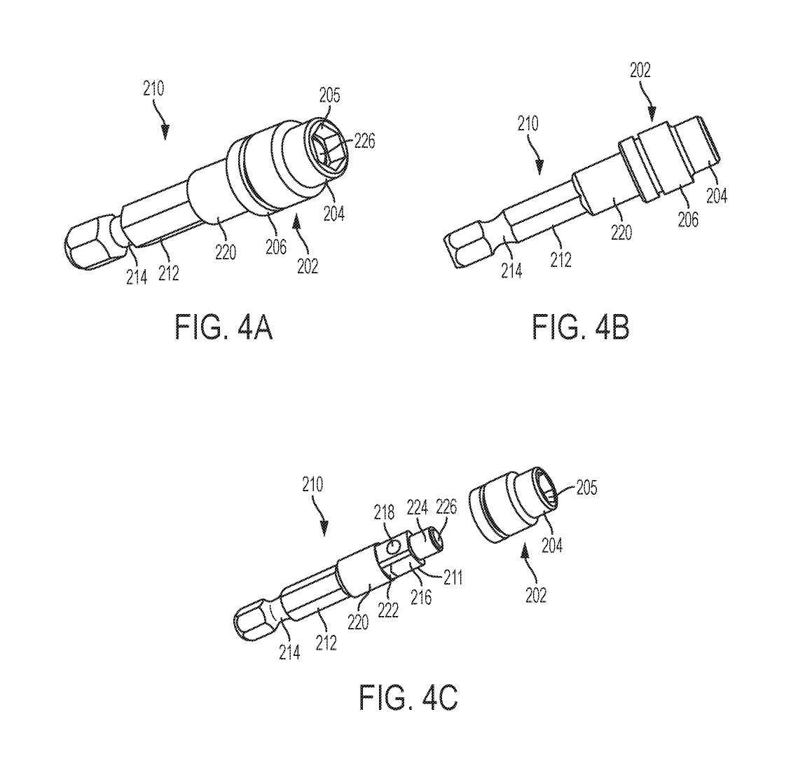

FIGS. 4A-4C show a second embodiment of a magnetic socket adapter 210 for use with a plurality of socket drivers 202 of different sizes, similar to the magnetic socket adapter 110 and socket driver 102 of the first embodiment. The adapter 210 has a rear polygonal (e.g., hex) shaped shank 212 with an annular groove 214 for retaining the adapter 210 in a tool holder or chuck of a power tool or hand tool. The adapter 210 also has a front shaft 211 having a polygonal (e.g., hex or square) shaped head 216 with a retaining ball 218 that is biased radially outward for removably retaining a socket driver 202. A round intermediate shaft 220 is disposed between the shank 212 and the head 216. A ledge 222 is formed on the front of the round intermediate shaft 220 at the junction with the front head 216 so that the base of the socket driver 202 rests against the ledge 222 when it is coupled to the adapter 210. The front shaft 211 also has a non-polygonal (e.g., cylindrical or double D shaped) projection 224 with a magnet 226 at its front end extending axially forward of the head 216.

Each socket driver 202 has a front portion 204 with a polygonal (e.g., hex) shaped socket 205 of a different size to drive different sized nuts and fasteners. Each socket driver 202 also has a rear portion 206 with a polygonal (e.g., hex or square) shaped opening for receiving the front head 216 to retain the socket 202 on the adapter 210. Each socket 202 also has a cylindrical bore (not shown) extending between the socket in the front portion 204 and the opening in the rear portion 206 for receiving the projection 224 of the adapter 210. When the socket 202 is coupled to the adapter 210, the projection 224 extends through the cylindrical bore so that the magnet 226 is positioned at the bottom of the socket to retain a nut or fastener inside the socket. The magnetic socket adapter 210 differs from the magnetic socket adapter 110 in that the ledge 222 is at a junction between the round intermediate shaft 220 and the head 216 and the projection 224 is shorter in axial length than the projection 124.

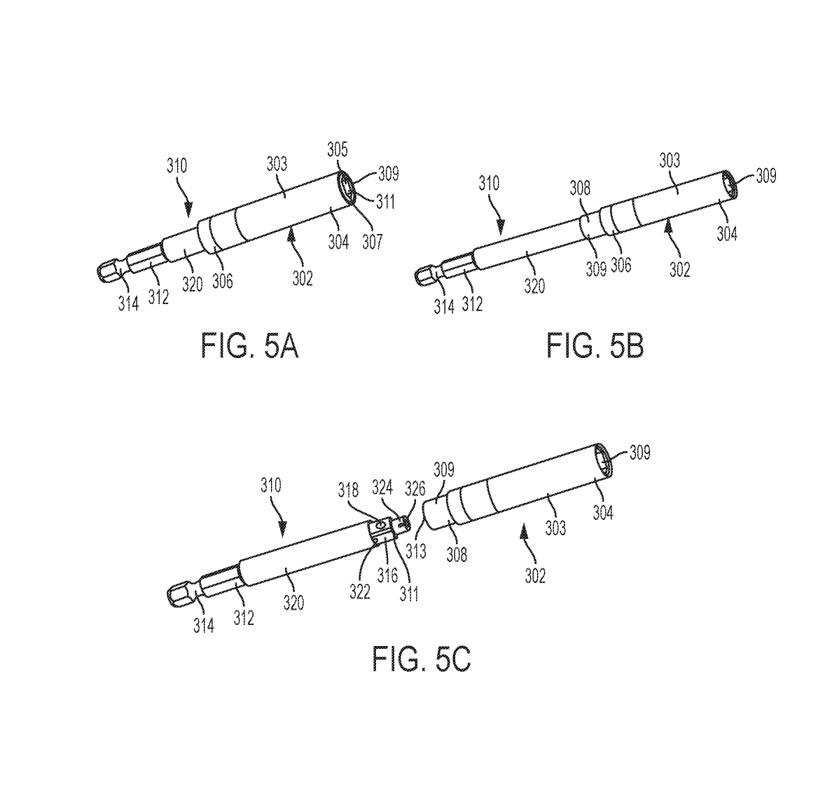

FIGS. 5A-5C show a third embodiment of a magnetic socket adapter 310, similar to the adapters 110, 120, can be used with a drive guide (similar to the drive guides disclosed in U.S. patent application Ser. No. 14/811,873, filed Jul. 29, 2015, titled “Drive Guide for Fastening Bits,” which is incorporated by reference). The adapter 310 has a rear polygonal (e.g., hex) shaped shank 312 with an annular groove 314 for retaining the adapter 310 in a tool holder or chuck of a power tool or hand tool. The adapter 310 also has a front shaft 311 having a polygonal (e.g., hex or square) shaped head 316 with a retaining ball 318 that is biased radially outward for removably retaining a socket driver 302. A round intermediate shaft 320 is disposed between the shank 312 and the head 316. A ledge 322 is formed on the front of the round intermediate shaft 320 at the junction with the front head 316 so that the base of the socket driver 302 rests against the ledge 322 when it is coupled to the adapter 310. The front shaft 311 also has a non-polygonal (e.g., cylindrical or double D shaped) projection 324 with a magnet 326 at its front end extending axially forward of the head 316.

The drive guide 302 has a drive shaft 308 and a sliding sleeve 303 received over the drive shaft 308. The drive shaft 308 has a rear portion 309 with a polygonal (e.g., hex or square) shaped opening 313 for receiving the front head 316 and the retaining ball 318 to retain the drive shaft 308 on the adapter 310. The drive shaft 308 also has a front portion 307 with a hex shaped socket 311 for receiving a screwdriving bit, and a cylindrical bore (not shown) extending between the hex shaped socket 311 and the polygonal shaped opening 313. When the drive shaft 308 is coupled to the adapter 310, the projection 324 extends through the cylindrical bore so that the magnet 326 is positioned at the bottom of the socket 311 to retain a screwdriving bit inside the socket 311. The sliding sleeve 303 is hollow and cylindrical with a front end 304 and a rear end 306, each including a stop (e.g., a hog ring, C-clip, inward shoulder), as described in more detail in the aforementioned U.S. patent application Ser. No. 14/811,873. The sleeve 303 can slide relative to the drive shaft 308 between a rear position (FIG. 5A) where the at the front end 304 limits further rearward movement of the sleeve 303, and a front position (FIG. 5B) where the stop at the rear end 306 limits further forward movement of the sleeve 303 In the rearward position (FIG. 5A), the front end 304 of the sleeve 303 is flush with the front end 307 of the drive shaft 308 to facilitate inserting and removing a screwdriving bit from the socket 311.

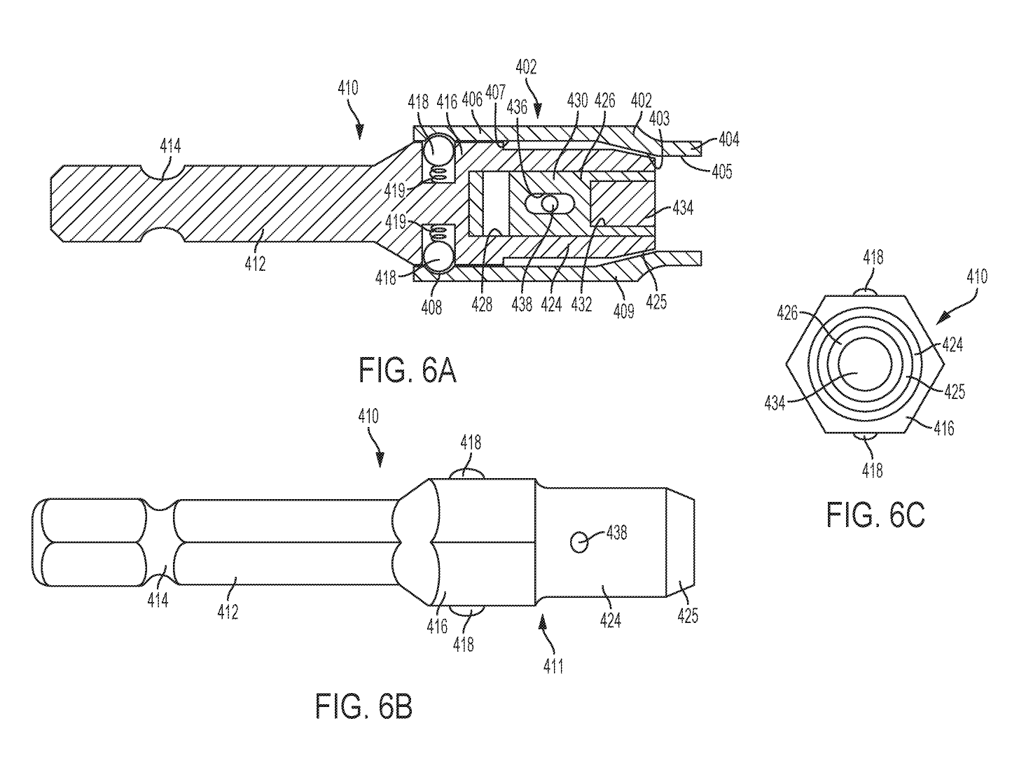

FIGS. 6A-6C show a fourth embodiment of a magnetic socket adapter 410 for use with a plurality of socket drivers 402 of different sizes. The adapter 410 has a rear polygonal (e.g., hex) shaped shank 412 with an annular groove 414 for retaining the adapter 410 in a tool holder or chuck of a power tool or hand tool. The adapter 410 also has a front shaft 411 having a polygonal (e.g., hex or square) shaped head 416 with a pair of retaining balls 418 that are biased radially outward by springs 419 for removably retaining a socket driver 402. The front shaft 411 also has a non-polygonal (e.g., cylindrical or double-D shaped) projection 424 with an outer conical centering surface 425 at its front end extending axially forward of the head 416. The projection 424 has an axial round bore 428 that receives a floating magnet assembly 426. The floating magnet assembly 426 includes a cylindrical magnet holder 430 with a front recess 432 that receives a magnet 434. The magnet holder 430 defines a longitudinal slot 436 that receives a cross-pin 438 that is fixed to the projection 424 transverse to its longitudinal axis. The cross-pin 438 and slot 436 allows the magnet holder 430 to float axially along the longitudinal axis by a limited extent, without being biased in an axial direction.

Each socket driver 402 has a front portion 404 with a polygonal (e.g., hex) shaped socket 405 of a different size to drive different sized nuts and fasteners. Each socket driver 402 also has a rear portion 406 with a polygonal (e.g., hex or square) shaped opening 407 for receiving the head 416. The shaped opening 407 further includes an annular groove 408 or a pair of recesses that is configured to receive the balls 418 to retain the socket driver 402 on the adapter 410. The socket driver 402 also has an intermediate portion 409 with a conical inner wall 403 that abuts against the outer conical surface 425 on the projection 424 to center the socket driver 402 on the adapter 410. When the socket 402 is coupled to the adapter 410, the magnet 434 is positioned adjacent the bottom of the socket 405 and allowed to float by a limited extent to retain a nut or fastener inside the socket 405. A plurality of socket drivers 402 with different sized sockets 405 can be removably coupled to the socket adapter 410.

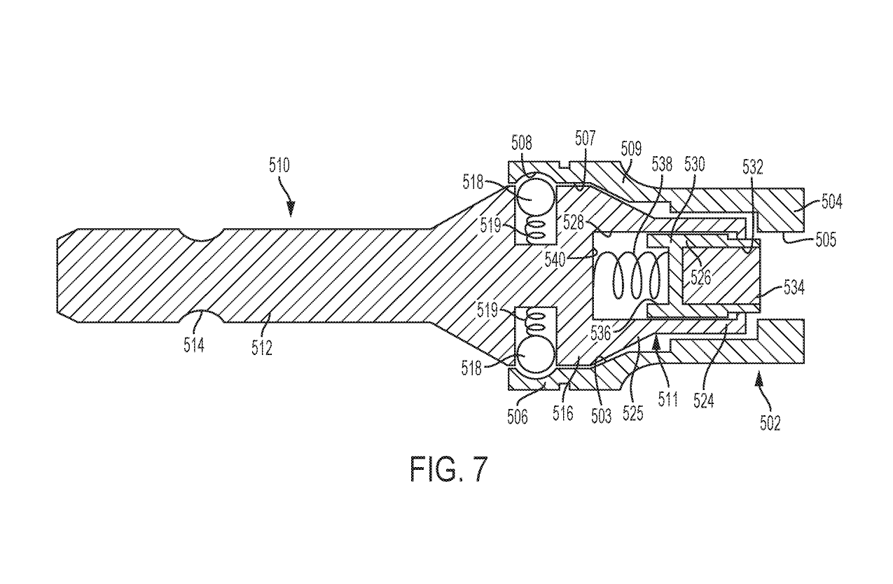

FIG. 7 shows a fifth embodiment of a magnetic socket adapter 510 for use with a plurality of socket drivers 502 of different sizes, similar to the adapter 410 and socket drivers 402 of the fourth embodiment. The adapter 510 has a rear polygonal (e.g., hex) shaped shank 512 with an annular groove 514 for retaining the adapter 510 in a tool holder or chuck of a power tool or hand tool. The adapter 510 also has a front shaft 511 having a polygonal (e.g., hex or square) shaped head 516 with a pair of retaining balls 518 that are biased radially outward by springs 519 for removably retaining a socket driver 502. The front shaft 511 also has a non-polygonal (e.g., cylindrical or double D shaped) projection 524 extending axially forward of the head 516. An outer conical centering surface 525 is disposed at a junction between the projection 524 and the head 516. The projection 524 has an axial round bore 528 that receives a floating magnet assembly 526. The floating magnet assembly 526 includes a cylindrical magnet holder 530 with a front recess 532 that receives a magnet 534. The magnet holder 530 has a rear recess 536 that receives a spring 538 fixed to a bottom wall 540 of the round bore 528. The spring 538 biases the magnet holder 530 axially forward and allows the magnet holder 530 to float axially along the longitudinal axis by a limited extent.

Each socket driver 502 has a front portion 504 with a polygonal (e.g., hex) shaped socket 505 of a different size to drive different sized nuts and fasteners. Each socket driver 502 also has a rear portion 506 with a polygonal (e.g., hex or square) shaped opening 507 for receiving the head 516. The polygonal opening 507 further includes an annular groove 508 or a pair of recesses that is configured to receive the balls 518 to retain the socket driver 502 on the adapter 510. The socket driver 502 also has an intermediate portion 509 with a conical inner wall 503 that abuts against the conical surface 525 to center the socket driver 502 on the adapter 510. When the socket 502 is coupled to the adapter 510, the magnet 534 is positioned adjacent the bottom of the socket 505 and allowed to float by a limited extent to retain a nut or fastener inside the socket 505. A plurality of socket drivers 502 with different sized sockets 505 can be removably coupled to the socket adapter 510.

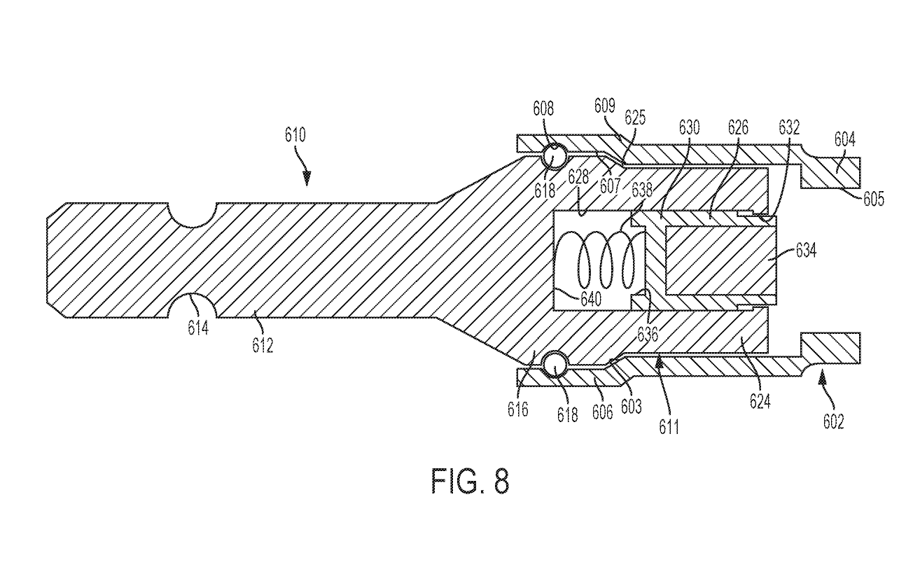

FIG. 8 shows a sixth embodiment of a magnetic socket adapter 610 for use with a plurality of socket drivers 602 of different sizes, similar to the adapter 510 and socket driver 502 of the fifth embodiment. The adapter 610 has a rear polygonal (e.g., hex) shaped shank 612 with an annular groove 614 for retaining the adapter 610 in a tool holder or chuck of a power tool or hand tool. The adapter 610 also has a front shaft 611 having a polygonal (e.g., hex or square) shaped head 616 with a stop 618 (e.g., a C-clip, an E-clip, or an O-ring) for removably retaining a socket driver 602. The front shaft 611 also has a non-polygonal (e.g., cylindrical or double D shaped) projection 624 extending axially forward of the head 616. An outer conical centering surface 625 is disposed at a junction between the projection 624 and the head 616. The projection 624 has an axial round bore 628 that receives a floating magnet assembly 626. The floating magnet assembly 626 includes a cylindrical magnet holder 630 with a front recess 632 that receives a magnet 634. The magnet holder 630 has a rear recess 636 that receives a spring 638 fixed to a bottom wall 640 of the round bore 628. The spring 638 biases the magnet holder 630 axially forward and allows the magnet holder 630 to float axially along the longitudinal axis by a limited extent.

Each socket driver 602 has a front portion 604 with a polygonal (e.g., hex) shaped socket 605 of a different size to drive different sized nuts and fasteners. Each socket driver 602 also has a rear portion 606 with a polygonal (e.g., hex or square) shaped opening 607 for receiving the head 616. The polygonal opening 607 further includes an annular groove 608 that is configured to receive the stop 618 to removably retain the socket driver 602 on the adapter 610. The socket driver 602 also has an intermediate portion 609 with a conical inner wall 603 that abuts against the outer conical surface 625 to center the socket driver 602 on the adapter 610. When the socket 602 is coupled to the adapter 610, the magnet 634 is positioned adjacent the bottom of the socket 605 and allowed to float by a limited extent to retain a nut or fastener inside the socket 605. A plurality of socket drivers 602 with different sized sockets 605 can be removably coupled to the socket adapter 610.

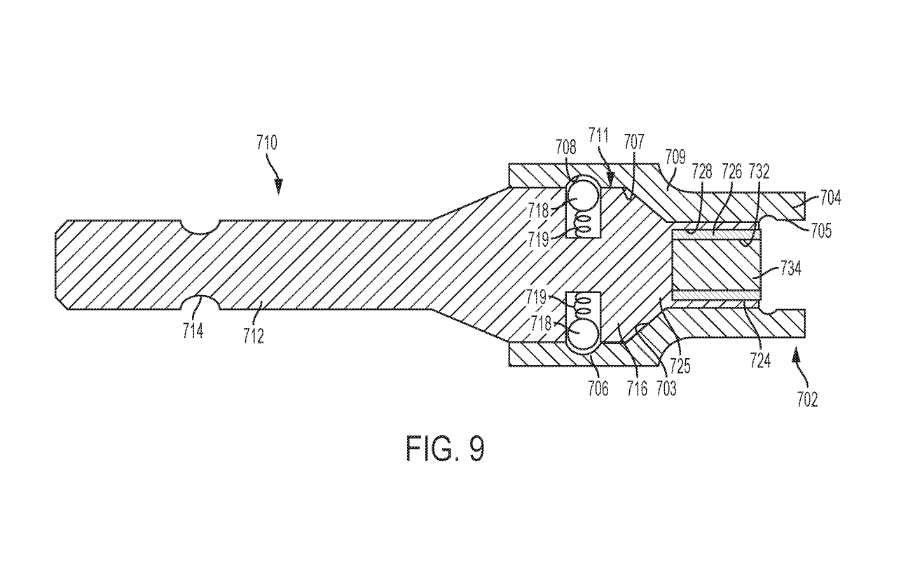

FIG. 9 shows a seventh embodiment of a magnetic socket adapter 710 for use with a plurality of socket drivers 702 of different sizes, similar to the adapter 510 and socket drivers 502 of the fifth embodiment. The adapter 710 has a rear polygonal (e.g., hex) shaped shank 712 with an annular groove 714 for retaining the adapter 710 in a tool holder or chuck of a power tool or hand tool. The adapter 710 also has a front shaft 711 having a polygonal (e.g., hex or square) shaped head 716 with a pair of retaining balls 718 that are biased radially outward by springs 719 for removably retaining a socket driver 702. The front shaft 711 also has a non-polygonal (e.g., cylindrical or double D shaped) projection 724 extending axially forward of the head 716. An outer conical centering surface 725 is disposed at a junction between the projection 724 and the head 716. The projection 724 has an axial round bore 728 that receives a magnet assembly 726. The magnet assembly 726 includes a cylindrical magnet holder 730 with a front recess 732 that receives a magnet 734. The magnet holder 730 is fixed in the round bore 728.

Each socket driver 702 has a front portion 704 with a polygonal (e.g., hex) shaped socket 705 of a different size to drive different sized nuts and fasteners. Each socket driver 702 also has a rear portion 706 with a polygonal (e.g., hex or square) shaped opening 707 for receiving the head 716. The polygonal opening 707 further includes an annular groove 708 or a pair of recesses that is configured to receive the balls 718 to retain the socket driver 702 on the adapter 710. The socket driver 702 also has an intermediate portion 709 with a conical inner wall 703 that abuts against the outer conical surface 725 to center the socket driver 702 on the adapter 710. When the socket 702 is coupled to the adapter 710, the magnet 734 is positioned adjacent the bottom of the socket 705 to retain a nut or fastener inside the socket 705. A plurality of socket drivers 702 with different sized sockets 705 can be removably coupled to the socket adapter 710.

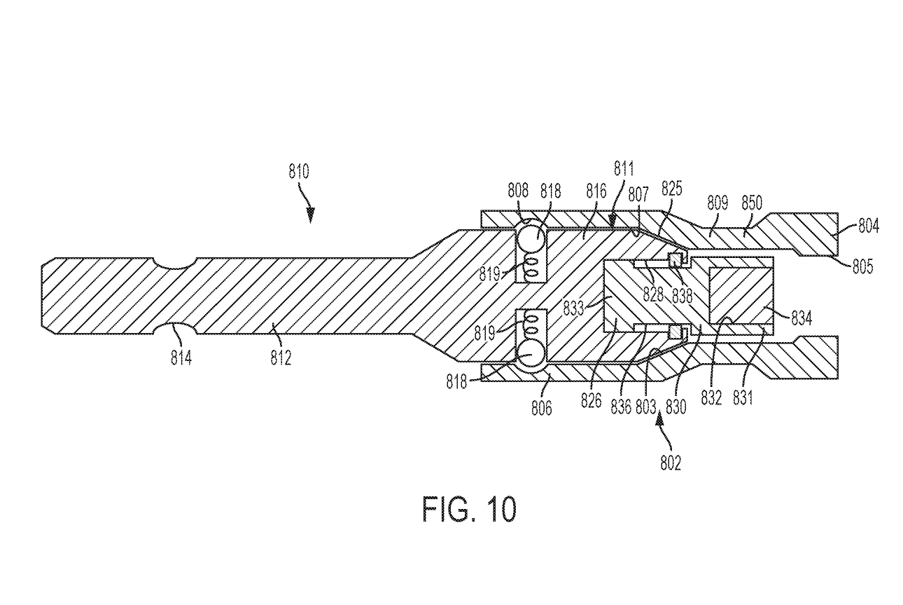

FIG. 10 shows an eighth embodiment of a magnetic socket adapter 810 for use with a plurality of socket drivers 802 of different sizes, similar to the adapter 410 and socket drivers 402 of the fourth embodiment. The adapter 810 has a rear polygonal (e.g., hex) shaped shank 812 with an annular groove 814 for retaining the adapter 810 in a tool holder or chuck of a power tool or hand tool. The adapter 810 also has a front shaft 811 having a polygonal (e.g., hex or square) shaped head 816 with a pair of retaining balls 818 that are biased radially outward by springs 819 for removably retaining a socket driver 802. The front end of the head 816 has a conical centering surface 825. The head 816 has an axial round bore 828 that receives a floating magnet assembly 826. The floating magnet assembly 826 includes a cylindrical magnet holder 830 with a front portion 831 that protrudes outward from the bore 828 and a rear portion 833 that is received in the bore 828. The front portion 831 of the magnet holder 830 defines a central opening 832 that receives a magnet 834. The rear portion 833 of the magnet holder 830 defines an annular recess 836 that receives a stop 838 (e.g., a C-clip, an E-clip, or an O-ring) that is fixed inside the bore 828. The annular recess 836 has a greater axial length than the width of the stop 838 so that the magnet holder 830 can float axially along the longitudinal axis by a limited extent, without being biased in an axial direction.

Each socket driver 802 has a front portion 804 with a polygonal (e.g., hex) shaped socket 805 of a different size to drive different sized nuts and fasteners. Each socket driver 802 also has a rear portion 806 with a polygonal (e.g., hex or square) shaped opening 807 for receiving the head 816. The opening 807 further includes an annular groove 808 or a pair of recesses that is configured to receive the balls 818 to retain the socket driver 802 on the adapter 810. The socket driver 802 also has an intermediate portion 809 with a conical inner wall 803 that abuts against the outer conical surface 825 to center the socket driver 802 on the adapter 810. When the socket 802 is coupled to the adapter 810, the magnet 834 is positioned adjacent the bottom of the socket 805 and allowed to float by a limited extent to retain a nut or fastener inside the socket 805. A plurality of socket drivers 802 with different sized sockets 805 can be removably coupled to the socket adapter 810.

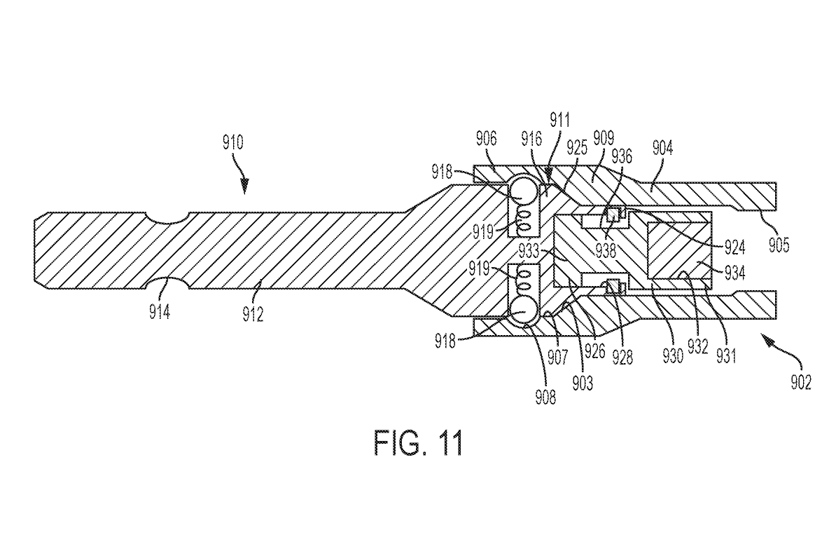

FIG. 11 shows an ninth embodiment of a magnetic socket adapter 910 for use with a plurality of socket drivers 902 of different sizes, similar to the adapter 810 and socket drivers 802 of the eighth embodiment. The adapter 910 has a rear polygonal (e.g., hex or square) shaped shank 912 with an annular groove 914 for retaining the adapter 910 in a tool holder or chuck of a power tool or hand tool. The adapter 910 also has a front shaft 911 having a polygonal (e.g., hex or square) shaped head 916 with a pair of retaining balls 918 that are biased radially outward by springs 919 for removably retaining a socket driver 902. The front shaft 911 also has a non-polygonal (e.g., cylindrical or double D shaped) projection 924 extending axially forward of the head 916. A conical centering surface 925 is disposed at a junction between the projection 924 and the head 916. The projection 924 has an axial round bore 928 that receives a floating magnet assembly 926. The floating magnet assembly 926 includes a cylindrical magnet holder 930 with a front portion 931 that protrudes outward from the bore 928 and a rear portion 933 that is received in the bore 928. The front portion 931 of the magnet holder 930 defines a central opening 932 that receives a magnet 934. The rear portion 933 of the magnet holder 930 defines an annular recess 936 that receives a stop 938 (e.g., a C-clip, an E-clip, or an O-ring) that is fixed inside the bore 928. The annular recess 936 has a greater axial length than the width of the stop 838 so that the magnet holder 930 can float axially along the longitudinal axis by a limited extent, without being biased in an axial direction.

Each socket driver 902 has a front portion 904 with a polygonal (e.g., hex) shaped socket 905 of a different size to drive different sized nuts and fasteners. Each socket driver 902 also has a rear portion 906 with a polygonal (e.g., hex or square) shaped opening 907 for receiving the head 916. The opening 907 further includes an annular groove 908 or a pair of recesses that is configured to receive the balls 918 to retain the socket driver 902 on the adapter 910. The socket driver 902 also has an intermediate portion 909 with a conical inner wall 903 that abuts against the conical surface 925 on the projection 924 to center the socket driver 902 on the adapter 910. When the socket driver 902 is coupled to the adapter 910, the magnet 934 is positioned adjacent the bottom of the socket 905 and allowed to float by a limited extent to retain a nut or fastener inside the socket 905. A plurality of socket drivers 902 with different sized sockets 905 can be removably coupled to the socket adapter 910.

Example embodiments have been provided so that this disclosure will be thorough, and to fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Terms of degree such as “generally,” “substantially,” “approximately,” and “about” may be used herein when describing the relative positions, sizes, dimensions, or values of various elements, components, regions, layers and/or sections. These terms mean that such relative positions, sizes, dimensions, or values are within the defined range or comparison (e.g., equal or close to equal) with sufficient precision as would be understood by one of ordinary skill in the art in the context of the various elements, components, regions, layers and/or sections being described.

Numerous modifications may be made to the exemplary implementations described above. These and other implementations are within the scope of the following claims.

What is claimed is:

1. A magnetic socket adapter configured to be removably coupled to a plurality of differently sized socket drivers, the magnetic socket adapter comprising:
a rear shank configured to be coupled to a tool holder or a chuck of a power tool or a hand tool;
a front shaft coupled to the shank and defining a longitudinal axis, the front shaft having a head with a polygonal outer surface configured to be received in a corresponding polygonal shaped opening in each of the plurality of socket drivers;
a retaining projection coupled to the head and configured to removably retain each of the plurality of socket drivers on the head;
a magnet coupled to a front end of the front shaft; and
an outer conical centering surface disposed on the front shaft and configured to abut a corresponding internal conical centering surface in the polygonal opening in each of the plurality of socket drivers to center the socket drivers on the front shaft.

2. The magnetic socket adapter of claim 1, wherein the front shaft has a projection extending axially forward of the head, the bore being defined in the projection.

3. The magnetic socket adapter of claim 2, wherein the outer conical centering surface is disposed at a junction between the head and the projection.

4. The magnetic socket adapter of claim 2, wherein the outer conical centering surface is disposed on a front end of the projection.

5. The magnetic socket adapter of claim 1, wherein the retaining projection includes at least one of a ball and an elastomeric ring extending radially outward from the head to engage a corresponding groove in the polygonal opening in each of the plurality of socket drivers.

6. The magnetic socket adapter of claim 1, wherein the magnet is coupled to a magnet holder received in a bore in the front shaft, the magnet holder configured to float axially along the longitudinal axis by a limited extent relative to the front shaft.

7. The magnetic socket adapter of claim 6, further comprising a spring biasing the magnet holder axially forward.

8. The magnetic socket adapter of claim 6, wherein the magnet holder includes a groove having a front end and a rear end and the front shaft has a stop fixedly attached to the front shaft, where the magnet holder can move axially between a rear position where the stop engages the front end of the groove and a front position in which the stop engages the rear end of the groove.

9. The magnetic socket adapter of claim 8, wherein the groove comprises an axial slot and the stop comprises a cross pin received in the slot.

10. The magnetic socket adapter of claim 8, wherein the groove comprises an annular groove and the stop comprises a ring on an inner surface of the bore and received in the annular groove.

11. The magnetic socket adapter of claim 6, wherein the magnet holder is configured to float axially without being biased in an axial direction.

12. A magnetic socket adapter set comprising:
a plurality of differently sized socket drivers, each socket driver having a rear end portion with a polygonal opening and a front end portion with a polygonal socket configured to receive a nut or fastener; and
a magnetic socket adapter having a rear shank configured to be coupled to a tool holder or a chuck of a power tool or a hand tool, a front shaft coupled to the shank, and a magnet coupled to a front end of the front shaft, the front shaft defining a longitudinal axis and having a head with a polygonal outer surface configured to be received in the polygonal opening in each of the plurality of socket drivers,
wherein the head includes a retaining projection configured to removably retain each of the plurality of socket drivers on the adapter, and
wherein the front shaft includes an outer conical centering surface configured to abut a corresponding internal conical centering surface in the polygonal opening in each of the socket drivers to facilitate centering the socket drivers on the front shaft.

13. The magnetic socket adapter set of claim 12, wherein the front shaft has a projection extending axially forward of the head, the bore being defined in the projection.

14. The magnetic socket adapter set of claim 13, wherein the outer conical centering surface is disposed at a junction between the head and the projection or on a front end of the projection.

15. The magnetic socket adapter set of claim 12, wherein the retaining projection includes at least one of a ball and an elastomeric ring extending radially outward from the head to engage a corresponding groove in the polygonal opening in each of the plurality of socket drivers.

16. The magnetic socket adapter set of claim 12, wherein the magnet is coupled to a magnet holder received in a bore in the front shaft, the magnet holder configured to float axially along the longitudinal axis by a limited extent relative to the front shaft.

17. The magnetic socket adapter set of claim 16, wherein the floating magnet assembly comprises a spring biasing the magnet holder axially forward from the bore.

18. The magnetic socket adapter set of claim 16, wherein the floating magnet assembly comprises a groove having a front end and a rear end defined in the magnet holder and a stop fixedly attached to the front shaft, where the magnet holder can move axially between a rear position where the stop engages the front end of the groove and a front position in which the stop engages the rear end of the groove.

19. The magnetic socket adapter set of claim 16, wherein the magnet holder is configured to float axially without being biased in an axial direction.

20. The magnetic socket adapter set of claim 12, further comprising a drive guide having a socket shaft configured to be removably retained on the head of the adapter, and a sliding sleeve received over the socket shaft and configured to be slidable between a rearward position and a frontward position.
